(19) United States
(12) Patent Application Publication
(10) Pub. No.: US 2003/0086547 A1
(43) Pub. Date: May 8, 2003

(54) Telephonic terminal system

(76) Inventor: Kevin Chuang, Taipei Hsien (TW)

Correspondence Address: J.C. Patents, Inc., Suite 250, 4 Venture, Irvine, CA, 92618, US

(21) Appl. No.: 10/005,319

(22) Filed: Nov. 8, 2001

(51) Int. Cl. H04M 1/64; H04M 11/00

(52) U.S. Cl. 379/142.06; 379/88.21; 379/93.23; 379/245

(57) ABSTRACT

A telephonic terminal system outputs vocal and picture signals to inform a user about an incoming phone call. A signal processing unit of the telephonic terminal system checks whether the incoming phone call signal can be identified in an internal data storage device that records a plurality data about various telephonic terminal users. If the incoming phone call signal is identified, a prompter including texts, vocal signals, and picture/video signals is outputted to inform the user of the origin of the incoming phone call signal. If the origin of the incoming phone call signal is not identified, the prompter accordingly informs the user. The telephonic terminal system further can catch pictures or video in snapshot fashion delivered from a remote telephonic terminal system.

### BACKGROUND OF THE INVENTION

1. Field of the Invention

The present invention relates to a telephonic terminal system. More particularly, the present invention relates to a telephonic terminal system that is user-friendlier.

2. Description of the Related Art

Conventional telephone devices may be provided with internal electronic directories for memorizing various telephone users with their corresponding telephone numbers. When a remote interlocutor calls in, the telephone device usually rings and a prompter may display on a digital screen of the telephone device the telephone number of the remote interlocutor and his or her name.

The above conventional telephone device may be inadequate with today's demands for a telephone device that can offer more functions and is user-friendly.

### SUMMARY OF THE INVENTION

An aspect of the present invention is therefore to provide a telephonic terminal system that is user-friendly by outputting text, vocal, and picture/video signals to inform a telephonic terminal user about an incoming phone call.

To accomplish the above and other objectives, the telephonic terminal system of the invention comprises a signal processing unit, a display device, a sound output device, and a data storage device. The data storage device is coupled to the signal processing unit and stores a plurality of data about a plurality of remote telephonic terminal users. The data stored in the data storage device include text/vocal data, picture data, and video data. The signal processing unit includes a text-to-speech device that can convert text data into vocal signals. The signal processing unit receives an incoming phone call signal and outputs a prompter to alert the user of the telephonic terminal system of an incoming phone call. To output the prompter, the signal processing unit checks whether the incoming phone call signal can be identified with at least one of the telephonic terminal users recorded in the data storage. If the origin of the incoming phone call signal is identified, the outputted prompter includes the corresponding data stored in the data storage device. These data related to the origin of the incoming phone call signal may be outputted as vocal and picture/video signals through the sound output device and the display device to inform the user of the origin of the incoming phone call. If the origin of the incoming phone call signal is not identified in the data storage device, the outputted prompter includes an information that indicates that the incoming phone call has not been identified in the data storage device. The prompter further may be setup to indicate that the incoming phone call is originated from either a group of telephonic terminal users or an individual telephonic terminal user identified within the data storage device. The telephonic terminal system further comprises a vocal input device, a picture input device, a picture pick-up device, and a text input device to record vocal data, picture/video data and text data into the data storage device. The picture pick-up device can further catch in snapshot fashion pictures transferred by a remote telephonic terminal user online.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flow chart illustrating various stages of a telephonic terminal system according to an embodiment of the invention;

FIG. 2 is a block diagram illustrating a telephonic terminal system according an embodiment of the invention; and

FIG. 3 is a diagram that illustrates an example of data format recorded in the telephonic terminal system of the invention.

### DESCRIPTION OF THE PREFERRED EMBODIMENTS

The features and advantages of the present invention will be more clearly understood from the following detailed description taken in conjunction with the accompanying drawings. The following detailed description is only illustrative of various specific structures that embody the present invention, and does not limit the scope of the invention. Wherever possible, like reference numerals refer to like elements or parts unless otherwise illustrated.

The invention provides a telephonic terminal system that is suitable for use with various telecommunication devices such as telephone devices and further provides the user with a friendlier interface.

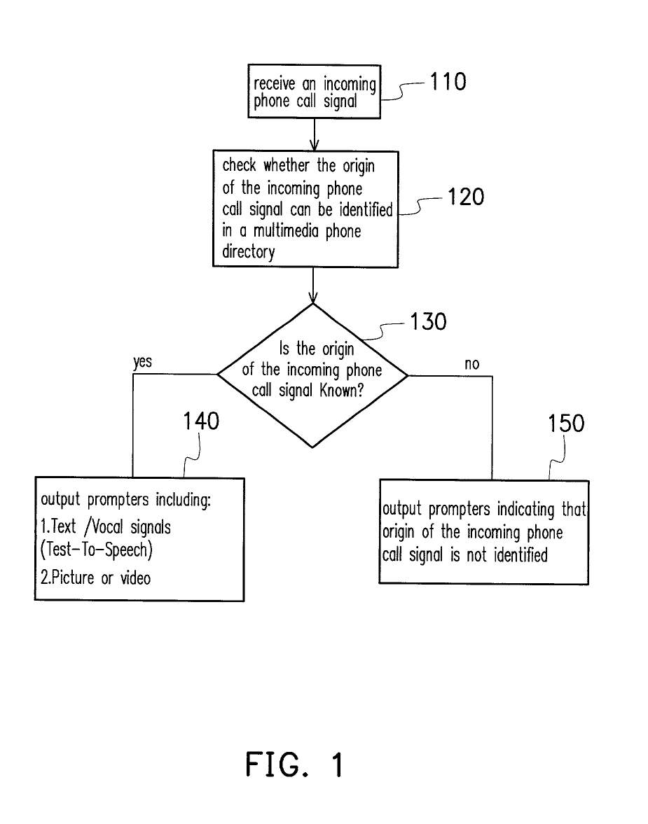

Referring now to FIG. 1, a flow chart schematically illustrates various stages of a telephonic terminal system according to an embodiment of the invention. At step 110, an incoming phone call signal is received by a telephonic terminal system of the invention. At receiving the phone call signal, the telephonic terminal system outputs a prompter that alerts the user of the incoming phone call. To output the prompter, the telephonic terminal system, at step 120, checks whether the origin of the incoming phone call signal can be identified within a multimedia phone directory setup within the telephonic terminal system. The multimedia phone directory, updated by the user, includes a plurality of data about various remote telephonic terminal users. Those data may be of various types including, for example, texts, images, videos, or text-to-speech (TTS) data. If the incoming phone call is identified, the outputted prompter further informs the user of the origin of the incoming call signal (step 140). The prompter may include, for example, a vocal prompter obtained by converting text data into vocal signals, and/or picture or video data. If the incoming phone call signal is not identified in the multimedia phone directory, the outputted prompter alerts the user that no information about the incoming phone call is recorded (step 150).

The type of prompter that may be outputted depends on the equipment provided on the telephonic terminal system of the invention. The user can define various types of prompters for different origins of incoming phone call signal. The prompter may be a text accompanied with a vocal signal, a picture, or a video, all of which may be either preset by the user within the multimedia phone directory or provided by the incoming phone call signal. When the incoming phone call signal generates a prompter that includes specific data not recorded in the multimedia phone directory, those data can be automatically recorded by the telephonic terminal system. When the prompter includes a text, the text is further converted into a vocal signal via a text-to-speech device to vocally inform the user of the origin of the incoming phone call. The textual and vocal prompter may inform the user of, for example, the name of the interlocutor calling in and the corresponding phone number. If desired, the user may go through the multimedia phone directory to obtain further information about the person calling in or list out other information recorded in the multimedia phone directory.

Besides, the user may preset the prompter of the incoming phone call to identify the origin of the incoming phone call as a group or an individual person. To identify the origin of the incoming phone call as a group, the user first must attribute various telephonic terminal users recorded in the multimedia phone directory to different groups. Various groups such as “family members” or “work colleagues”, for example, may be therefore created. When an incoming phone call is identified as from a specific group, a specific prompter is outputted to indicate the identified group of the incoming phone call.

The user can record a plurality of names of various telephonic terminal users with their related data such as telephone numbers into the multimedia phone directory. The information related to each telephonic terminal user may comprise various types of data such as picture data, video data, or text data stored within the multimedia phone directory. When the user wants to search for an information about one specific telephonic terminal user, the telephonic terminal system may list out an index of, for example, all the names of telephonic terminal users recorded to allow a search by name.

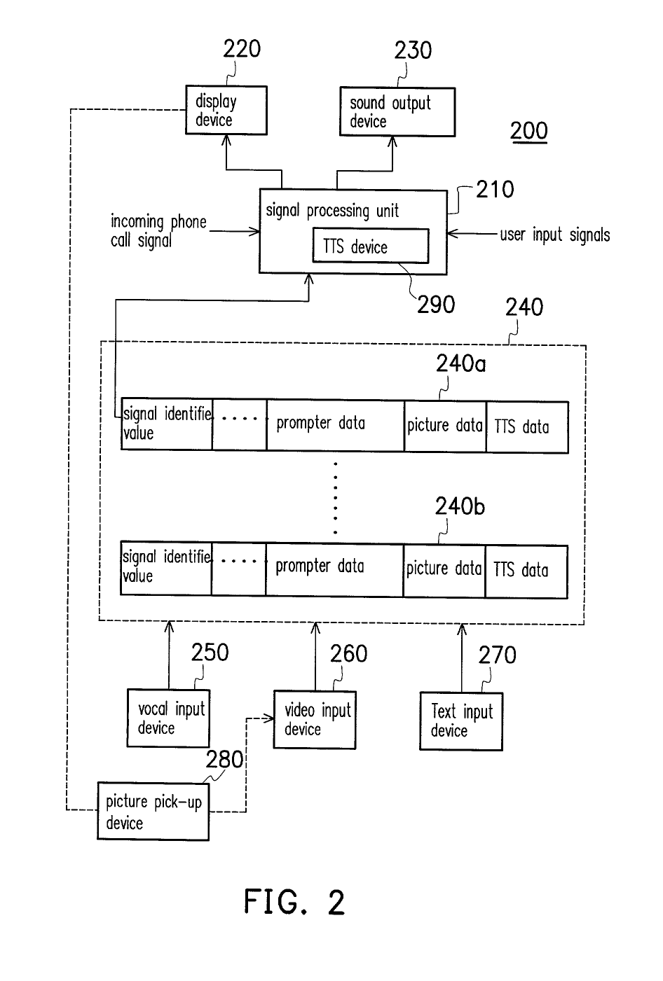

Referring now to FIG. 2, a block diagram schematically illustrates a telephonic terminal system according to an embodiment of the invention. A telephonic terminal system 200 comprises a signal processing unit 210, a display device 220, a sound output device 230, a data storage device 240, a vocal input device 250, a picture input device 260, and a text input device 270. The data storage device 240 records a plurality of data 240a, 240b that form the multimedia phone directory, wherein each set of data 240a, 240b respectively contains data about one remote telephonic terminal user. In the example of this embodiment, data are stored in the data storage device 240 by means of the vocal input device 250, the picture input device 260, and the text input device 270. The signal processing unit 210 further includes a text-to-speech device 290 that can convert text data into vocal signals. The signal processing unit 210 may also receive input signals from the user to process search and update operations within the data storage device 240. The telephonic terminal system as described above is preferably used with telephonic equipment having a liquid crystal display screen to enable a picture and video display. However, other telephonic equipment may be also compatible with the telephonic terminal system of the invention.

When the telephonic terminal system 200 receives an incoming phone call signal, the signal processing unit 210 checks whether the incoming phone call signal can be identified with one of the telephonic terminal users recorded in the data storage device 240. The identification of the incoming phone call signal may be achieved with respect to, for example, a signal identifier in each set of data 240a, 240b that is compared to the incoming phone call signal.

If the signal processing unit 210 has identified the origin of the incoming phone call signal in the data storage device 240, the corresponding data including text data, vocal signals, and/or picture/video data are outputted via the display device 220 and sound output device 230 to inform the user.

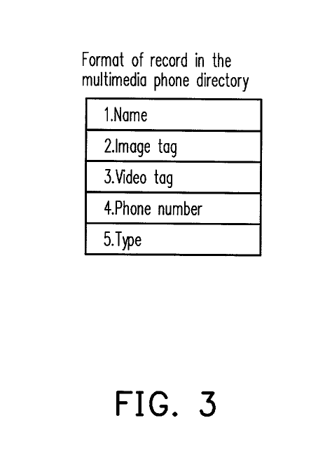

FIG. 3 schematically illustrates an example of format according to which information may be recorded in the multimedia phone directory. The format according to which data are stored into the multimedia phone directory may include a telephonic terminal user's name, a picture tag, a video tag, a phone number, and a type field. The type field may identify the group to which a telephonic terminal user may belong, and the picture tag and video tag identify the picture data and the video data attributed to the telephonic terminal user and stored in the data storage device 240.

As illustrated in FIG. 2, the text data, vocal data, and picture and video data may be recorded into the data storage device 240 via the text input device 270, vocal input device 250, and picture input device 260. The picture and video data may be transferred into the data storage device 240 from a personal computer, for example. Additionally, the telephonic terminal system 200 of the invention may be provided with a picture pick-up device 280 to catch images or moving pictures in snapshot fashion transferred by a remote telephonic terminal user online.

In this embodiment of the invention, when an incoming phone call is identified in the multimedia phone directory, the telephonic terminal system 200 preferably first outputs a vocal signal that informs the user of the remote caller's phone number. Depending on the caller's data that are stored in the multimedia phone directory, the telephonic terminal system 200 then may vocally inform the user of the caller's name and show the corresponding picture or video data recorded in the multimedia phone directory. Vocal signals are outputted by means of the TTS device 290 that converts text data into vocal signals. Instead of the caller's name, the telephonic terminal system 200 may alternatively inform the user of the group to which the caller belongs if this information is provided in the multimedia phone directory.

If the incoming phone call cannot be identified in the data storage device 240, the telephonic terminal system 200 may vocally and textually informs the user of the phone number from which the incoming phone call is originated if the incoming phone call signal provides this information. If no phone number is provided, a specific vocal and textual prompter may be outputted to inform the user that no phone number is provided with the incoming phone call signal. In addition to vocal and textual signals, picture or video outputs may be further preset to alert the user when no phone number is provided by the incoming phone call signal or when the origin of the incoming phone call is not identified in the multimedia phone directory.

In conclusion, the above telephonic terminal system of the invention outputs audio and video signals to provide the telephonic terminal user with a friendlier interface when receiving an incoming phone call. The telephonic terminal user can be thereby friendly and accurately informed of the origin of an incoming phone call before he or she being effectively online with the remote interlocutor. The telephonic terminal system of the invention is suitable for use with various types of telecommunication devices such as telephone devices, telephone/fax devices, etc.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A telephonic terminal system comprising:
a signal processing unit, wherein the signal processing unit can receive and process an incoming phone call signal;
a display device coupled to the signal processing unit;
a sound output device coupled to the signal processing unit; and
a data storage device coupled to the signal processing unit, wherein the data storage device records a plurality of data about a plurality of telephonic terminal users, wherein the telephonic terminal system outputs a plurality of first vocal and picture signals through the sound output device and the display device to inform a user of the telephonic terminal system about the origin of an incoming phone call signal if the origin of the incoming phone call signal is identified as one of the telephonic terminal users recorded in the data storage device, and wherein the telephonic terminal system outputs a plurality of second vocal and picture signals to inform the user that the origin of an incoming phone call signal is not known if the origin of the incoming phone call signal is not identified as any of the telephonic terminal users recorded in the data storage device.

2. A telephone device provided with the telephonic terminal system of claim 1.

3. The system of claim 1, wherein the user can further preset a prompter of the telephonic terminal system to indicate that an incoming phone call signal is from either a group of telephonic terminal users or an individual telephonic terminal user.

4. The system of claim 1, wherein the data storage device may store a plurality of picture data for each of the telephonic terminal users recorded therein.

5. The system of claim 1, wherein the data storage device may store a plurality of video data for each of the telephonic terminal users recorded therein.

6. The system of claim 1, wherein the signal processing unit includes a text-to-speech device that can convert a plurality of text data stored in the data storage device into vocal signals to be outputted to the user via the sound output device.

7. The system of claim 1, wherein the data related to each of the telephonic terminal users are recorded in the data storage device according to a format that includes:
a name field;
a picture tag field;
a video tag field;
a phone number field; and
a type field, wherein the type field indicates whether the telephonic terminal user is identified as a single individual or as belonging to a group.

8. A telephone device comprising:
a signal processing unit that can receive and process an incoming phone call signal;
a display device coupled to the signal processing unit;
a sound output device coupled to the signal processing unit; and
a data storage device coupled to the signal processing unit, wherein the data storage device stores a plurality of data about a plurality of telephone users, wherein the signal processing unit checks whether the origin of an incoming phone call signal is one of the telephone users recorded in the data storage device so as to output vocal and picture information via the sound output device and the display device to inform a user of the telephone device about the origin of the incoming phone call signal.

9. The device of claim 8, wherein the user can further preset a prompter of the telephone device to indicate that an incoming phone call signal is from either a group of telephone users or an individual telephone user.

10. The device of claim 8, wherein the data storage device may store a plurality of picture data for each of the telephone users recorded therein.

11. The device of claim 8, wherein the data storage device may store a plurality of video data for each of the telephone users recorded therein.

12. The device of claim 8, wherein the data storage device includes a plurality of text data that can be converted into vocal signals to be outputted to the user of the telephone device via the sound output device.

13. The device of claim 8, further including a video input device coupled to the data storage device, wherein the video input device transfers a plurality of video data into the data storage device.

14. The device of claim 8, further including a picture pick-up device connected to the data storage device, wherein the picture pick-up device can catch pictures in snapshot fashion.

15. The device of claim 14, wherein the picture pick-up device can catch pictures transferred by a remote telephone user online to the telephone device so that the caught pictures can be stored in the data storage device.

16. The device of claim 8, further including a vocal input device coupled to the data storage device so that vocal signals can be recorded into the data storage device.

17. The device of claim 8, further including a text input device and a text-to-speech device respectively coupled to the data storage device so that text data can be recorded into the data storage device and converted into vocal signals outputted via the sound output device.

18. The device of claim 8, wherein the signal processing unit can receive a user input signal to perform search and update operations within the data storage device.

19. The device of claim 8, wherein the data related to each of the telephone users are recorded in the data storage device according to a format that includes:
a name field;
a picture tag field;
a video tag field;
a phone number field; and
a type field, wherein the type field indicates whether the telephonic terminal user is identified as a single individual or as belonging to a group.
